(19) United States
(12) Patent Application Publication
(10) Pub. No.: US 2015/0266361 A1
(43) Pub. Date: Sep. 24, 2015

(54) VEHICLE ROOF HAVING TWO LID MEMBERS

(71) Applicant: WEBASTO SE, Stockdorf (DE)

(72) Inventor: Martin Pollak, Germering (DE)

(21) Appl. No.: 14/400,589

(22) PCT Filed: Mar. 27, 2013
(86) PCT No.: PCT/EP2013/056601

§ 371 Date: May 29, 2015

(30) Foreign Application Priority Data
May 16, 2012 (DE) 10 2012 104 280.2

(51) Int. Cl. B60J 7/047; B60J 7/043

(52) U.S. Cl. CPC B60J 7/047; B60J 7/043

(57) ABSTRACT

The invention relates to a vehicle roof, comprising a lid arrangement (12) being adjustable between a closed position, in which a roof opening (26) is closed, and an uncovering position, in which the roof opening (26) is at least partially uncovered, and comprising a first lid member (14) and a second lid member (16), which, in the closed position of the lid arrangement (12), borders on the first lid member (14) and which is provided with a lowering and/or swing-away mechanism (30), such that the first lid member (14), which is guided via sliding members (32, 34) in guideways (36) of guide rails (24), which guideways are arranged on both sides of a vertical longitudinal center plane of the vehicle, can be traversed into an open position above the second lid member (16). The guideways (36) have such a path that the front lid member (14) performs a lifting movement relative to the second lid member (16) when being traversed into the open position.

The invention relates to a vehicle roof having the features of the preamble of claim 1.

Such a vehicle roof is known from document DE 103 30 786 B4 and comprises a lid arrangement being adjustable between a closed position, in which the roof opening is at least partially uncovered, and an uncovering position, in which the roof opening is at least partially uncovered. The lid arrangement comprises a front lid member, on the rear edge of which, in the closed position, a rear lid member borders. For uncovering the roof opening, the rear lid member is pivoted downwards, that is to say it is lowered, such that the front lid member can be traversed in the direction of the rear via the rear lid member. The front lid member, when being traversed, is guided via sliding members in guide rails that are fixed relative to the roof, wherein front sliding members are joined to the front lid member via pivotable levers, such that the front edge of the front lid member can perform a height compensation. In order to guarantee that the front lid member can be shifted in a non-colliding way, in the case of this vehicle roof, at least the front edge of the rear lid member has to be lowered significantly.

It is the object of the invention to create a vehicle roof of the type referred to in the introduction, in which the first lid member can be moved to be positioned above the second lid member with the aid of a simple and durable mechanism.

In accordance with the invention, this object is attained by the vehicle roof having the features of claim 1.

The essence of the invention therefore is that guide rails are envisaged for traversing the first lid member, the front lid member being lifted or lowered relative to the vehicle structure when being traversed in the longitudinal direction of the vehicle because of the characteristics of said guide rails. Hence, it is possible that the second lid member has to be lowered or swung away only marginally, in order to clear the traversing path for the lid member. The lifting movement that is needed when traversing the first lid member thus is decided by the guide rails or by the profile of the guideways of the guide rails alone. For traversing the first lid member, complex adjusting kinematics are not needed. The first lid member only has to be joined to adjusting means such as drive cables, which are rigid in compression. Hence, it is also possible to design the guide region for the first lid member, that is to say the guide rails, to be very slim, which, in turn, makes roof openings possible that have a very large extension in the transverse direction of the vehicle, since lateral roof beams can be configured to be very slim.

In a preferred embodiment of the vehicle roof according to the invention, the guide rails each include one guideway, respectively, for the sliding members, which guideway, starting from the closed position of the first lid member, has a first portion having an at least largely straight profile, which merges into a second portion being designed as a lifting portion via a first curved track, which second portion is designed to rise in the direction of the second lid member and merges into a third portion via a second curved track running in the opposite direction of the first curved track, which third portion is arranged in the region of the second lid member, which cannot be traversed, in relation to the longitudinal extension of the vehicle. Hence, the sliding members of the first lid member can be traversed, starting from the closed position, until they lie in the guide rail portions that are arranged next to the second lid member. With the vehicle roof according to the invention, it is hence also possible to design roof openings that allow large openings in the longitudinal direction of the vehicle.

In order to design the mechanism of the vehicle roof according to the invention to be as simple as possible, in a preferred embodiment of the vehicle roof according to the invention, all of the sliding members of the lid member are connected to the first lid member without any lever, that is to say at least largely rigidly. For example, simple angular guide pieces can be envisaged, which are designed as sliding members at their ends, the sliding members being guided in the guide rails.

In a special embodiment of the vehicle roof according to the invention, a fixed-roof portion abuts on the second lid member, the first lid member reaching over said fixed-roof portion in its uncovering position. Thus, the guide rails can also make a lifting movement possible that is performed by the first lid member when being traversed such that a protruding portion of the first lid member, which portion is not supported, projects over the fixed-roof portion in the uncovering position of the first lid member.

For the vehicle roof to be designed in such a way that it requires particularly little maintenance, the guide rails, in the closed position of the lid arrangement, are protected by the lid members towards the outside of the roof, preferably over their entire length. This means that the lid members, in the closed position, are arranged above the guideways of the guide rails. In the closed position, it is hence not possible that any dirt or dust enter the guide rails and the mechanism of the second lid member, since the regions concerned are sealed by the lid member seals. The guide rail portions that are arranged in the region of the first lid member are only uncovered, when the second lid member is lowered.

The sliding members of the first lid member are, in a preferred embodiment of the vehicle roof according to the invention, arranged such that they support the first lid member in a portion facing away from the second lid member in the closed position as well as in a central portion, whereas the first lid member is designed without any support in the edge region bordering on the second lid member in the closed position. Hence, it can be achieved in a simple manner that the first lid member is not only moved to be positioned above the second lid member, but that it is also moved to be positioned, with the portion without any support, above fixed-roof portions that might border thereon.

An embodiment of the vehicle roof according to the invention that is particularly optimized in terms of weight exists if the guide rails, at least in part, are made of plastic.

Expediently, the guide rails are respectively integrated into a lateral fixed-roof region, which is covered by an outer roof skin. Hence, in the opened state of the lid members, too, it is not or barely possible that dirt and dust enter the region of the guideways of the guide rails.

The vehicle roof according to the invention can be a panoramic roof, in which the first lid member and the second lid member are made of a transparent production material, for example made of glass. The first lid member is, for example, a front lid member, which is arranged above the front seats of a vehicle passenger compartment in its closed position, whereas the second lid member constitutes a rear lid member, which is arranged above the rear region of the vehicle passenger compartment. For example, the first lid member is twice as long as the second lid member in the longitudinal direction of the vehicle.

Further advantages and advantageous configurations of the subject-matter of the invention can be taken from the description, from the drawings and from the claims.

One exemplary embodiment of a vehicle roof according to the invention is illustrated in a schematically simplified way in the drawings and will be explained in more detail in the following. In the figures:

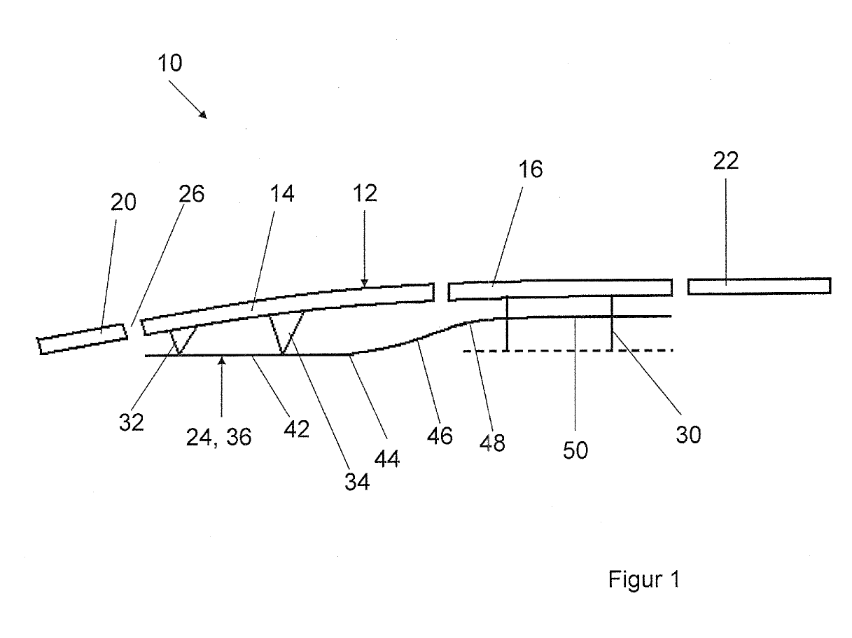

FIG. 1 shows a schematic side view of a vehicle roof according to the invention in a closed position of a lid arrangement;

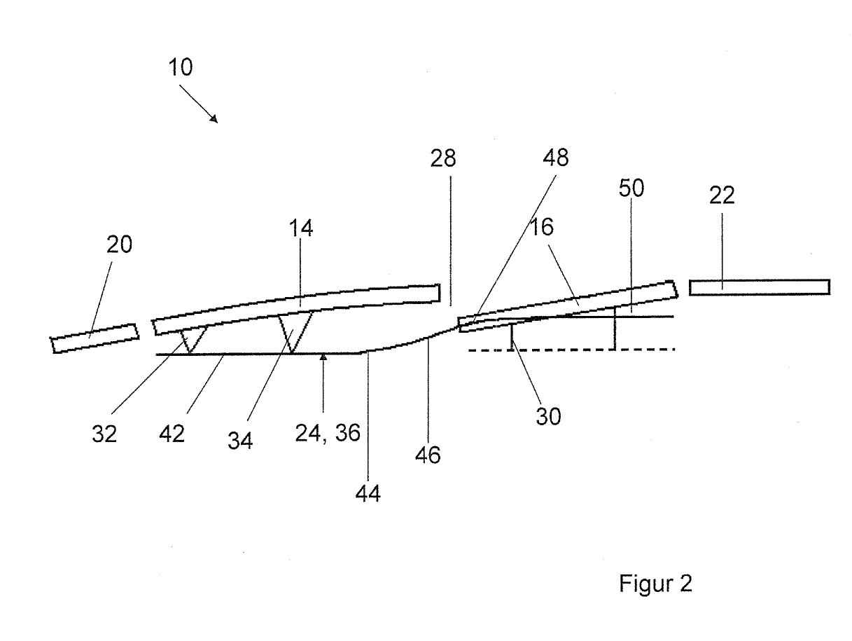

FIG. 2 shows a view that corresponds to FIG. 1, but with a rear lid member in ventilation position;

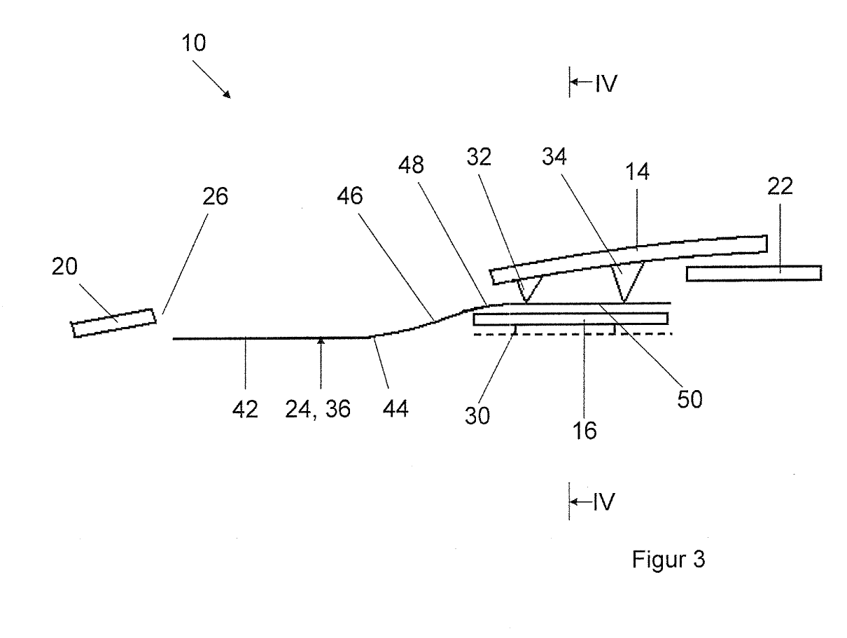

FIG. 3 also shows a view corresponding to FIG. 1, but with a front lid member that has been retracted; and

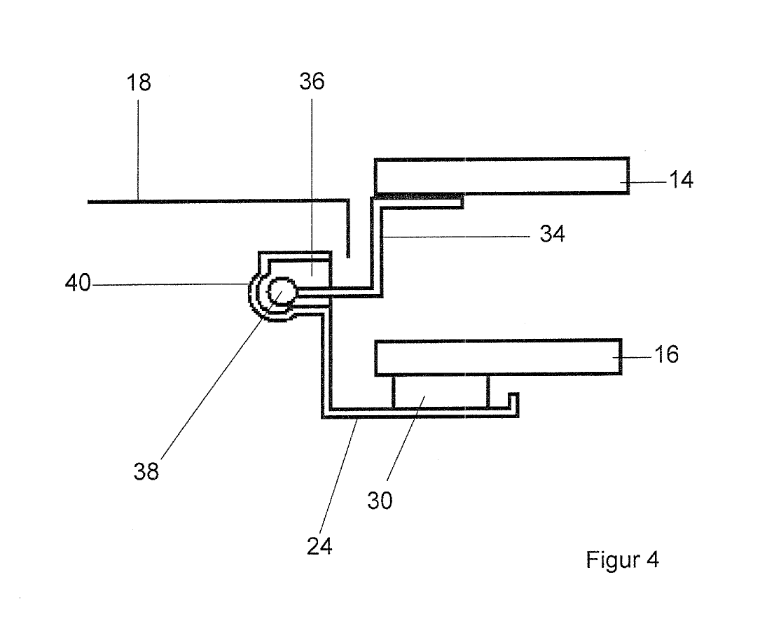

FIG. 4 shows a section through a lateral roof beam along line IV-IV in FIG. 3.

In the drawing, a vehicle roof 10 is illustrated, which is the roof of a motor vehicle being configured as a station wagon and constitutes a so-called panoramic roof having a roof opening system.

The vehicle roof 10 comprises a lid arrangement 12, which is formed by a front lid member 14 and by a rear lid member 16, which are respectively configured as glass lids. The two lid members 14 and 16, respectively in the transverse direction of the vehicle, extend between lateral fixed-roof regions, the fixed-roof region 18 thereof, which is arranged on the left with respect to the direction of travel, being illustrated in FIG. 4. In the closed position, the front lid member 14 borders on a front apron 20 in the front, which apron limits a windshield, which is not illustrated in more detail, at the upper edge thereof. In the rear, the front lid member 14, in the closed position, borders on the front edge of the rear lid member 16, said rear lid member, in turn, bordering on a rear fixed-roof portion 22 with its rear edge.

The front lid member 14 can be traversed from its closed position, which is illustrated in FIG. 1, into an uncovering position, which is illustrated in FIG. 3, and in which a roof opening 26 is uncovered, along lateral guide rails 24, which are integrated into the fixed-roof regions 18 having an outer skin.

The rear lid member 16, which cannot be traversed, can be pivoted from its closed position, which is illustrated in FIG. 1, into a ventilation position, which is illustrated in FIG. 2, and in which a gap 28 between the front edge of the rear lid member 16 and the rear edge of the front lid member 14 is designed, such that, via the gap 28, an exchange of air between a vehicle interior, which is not illustrated in more detail, and the vehicle environment is possible. Moreover, the rear lid member 16 can be moved into a lowered position which is plane-parallel to its closed position, and which is illustrated in FIG. 3. The rear lid member 16 is driven with the aid of adjusting kinematics 30, such as a lowering and/or swing-away mechanism, which are illustrated in a highly schematic way in the drawing.

The front lid member 14 includes one first slider 32, respectively, on both sides in its front edge region, and includes one slider 34, respectively, on both sides in a central region in relation to the longitudinal direction of the roof. Via the sliders 32 and 34, which are, for example, brought up as simple angles, and which are connected to the lid member 14 in a substantially rigid way, the lid member 14 is guided in the guideways 36 of guide rails 24 of said sliders, which guideways are arranged on both sides. The sliders 34 are respectively connected to a drive cable 38, which is rigid in compression, and which is guided in a cable channel 40 of the respective guide rail 24 and which can be driven with the aid of a drive motor for shifting the lid member 14.

In the rear of the sliders 34, which are arranged on both sides, the front lid member 14 does not include any further support.

The guideways 36 of the guide rails 24 each have a profile that is S-shaped at least in the broadest sense, such that the guideways 36 each include one first front portion 42, respectively, which merges into a second portion 46 via a curved track 44, which second portion is set relative to the first portion 42 and has a rising profile as seen in the rear region of the vehicle. The second portion 46, which constitutes a lifting portion, in turn merges into a rear third portion 50 via a second curved track 48, which is designed to run in the opposite direction of the first curved track 44, said third portion, in turn, having an at least largely straight profile and is justified to be parallel to the rear lid member 16 in the closed position thereof or in the lowered position thereof.

The guide rails 24, as seen in the transverse direction of the vehicle, each have a width of approximately 35 mm, such that the lid members 14 and 16 can be pulled up close to the edge of the vehicle roof 10 regarding their dimensions in the transverse direction of the vehicle. The guide rails 24 are at least largely made of plastic.

The vehicle roof 10 does not include any additional lifting or deploying mechanism for the front lid member 14.

In the closed position of the lid arrangement 12, i.e. in the position of the lid members 14 and 16 that is illustrated in FIG. 1, the guide rails 24 and also the drive kinematics 30 for the lid member 16 are arranged under the roof skin in a covered way. Hence, no risk exists that the guide rails 24 and the adjusting kinematics 30 are soiled.

In an alternative embodiment, the lid member 16 can, additionally or also alternatively, be lifted into a ventilation position, such that a corresponding gap is then designed between the front lid member and the rear lid member and/or between the rear lid member and the rear roof portion.

The vehicle roof that is illustrated in the drawing functions in the manner that is described in the following.

Starting from the closed position, which is illustrated in FIG. 1, for uncovering the roof opening 26, the rear lid member 16 is initially moved into its lowered position, which is illustrated in FIGS. 3 and 4, with the aid of the adjusting kinematics 30. Hence, the front lid member 14 is unlocked for being shifted in the rear direction. Now, the front lid member 14 can be dragged into the uncovering position with the aid of the drive cables 38 which are rigid in compression, such that, on grounds of the lifting movement that is decided by the path of the guideways 36, it is arranged above the lowered rear lid member 16 with its rear portion and with its central portion, and it is arranged above the fixed-roof portion 22 with its rear portion, which hangs over the sliders 36.

Closing the roof opening 24 is effected in a reversed manner.

### LIST OF REFERENCE NUMERALS

10 vehicle roof

12 lid arrangement

14 front lid member

16 rear lid member

18 lateral fixed-roof region

20 front apron

22 fixed-roof portion

24 guide rail

26 roof opening

28 gap

30 adjusting kinematics

32 slider

34 slider

36 guideway

38 drive cable

40 cable channel

42 first portion

44 first curved track

46 second portion

48 second curved track

50 third portion

1. A vehicle roof, said roof comprising:
a lid arrangement movable between a closed position closing a roof opening of a roof of a vehicle and an uncovering position at least partially uncovering the roof opening;
a first lid member forming part of the lid arrangement;
sliders guiding the first lid member;
guideways of guide rails arranged on opposite sides of a vertical longitudinal center plane of the vehicle, each guideway guiding at least one of the sliders, each guide rail being integrated with one lateral fixed-roof region and covered by an outer roof skin; and
a second lid member including a lowering and/or swing-away mechanism, the second lid member forming part of the lid arrangement and bordering on the first lid member when the lid arrangement is in the closed position wherein when the lid arrangement moves from the closed position to the uncovering position, each slider moves along one of the guideways and guides the first lid member, such that the first lid member performs a lifting movement relative to the second lid member when the lid arrangement moves toward the uncovering position.

2. The vehicle roof according to claim 1, in which the guideways for the sliding members each include one first portion, respectively, having an at least largely straight profile, which merges into a second portion being designed as a lifting portion via a first curved track, which second portion is set relative to the first portion and merges into a third portion via a second curved track running in the opposite direction of the first curved track, which third portion is arranged in the region of the second lid member in relation to the longitudinal extension of the vehicle and is set relative to the second portion.

3. The vehicle roof according to claim 1, the sliders of the first lid member are connected to the first lid member without any lever.

4. The vehicle roof according to claim 1, in which a fixed-roof portion abuts the second lid member, the first lid member reaching over said fixed-roof portion in the uncovering position.

5. The vehicle roof according to claim 1, in which the guide rails, in the closed position of the lid arrangement, are protected by the lid members towards an outside of the roof over an entire length of the guide rails.

6. The vehicle roof according to claim 1, in which lowering the second lid member or swinging the second lid member away allows the lid arrangement to move toward the uncovering position.

7. The vehicle roof according to claim 1, in which the sliders support the first lid member in a portion facing away from the second lid member in the closed position as well as in a central portion, and in that the first lid member is designed without any support in an edge region bordering on the second lid member in the closed position.

8. (canceled)

9. The vehicle roof according to claim 1, in which the guide rails are made of plastic.

10. A vehicle roof comprising:
a lid arrangement movable between a closed position and an uncovering position;
a first lid member forming part of the lid arrangement;
sliders guiding the first lid member to move the lid arrangement between the closed position and the uncovering position;
guideways of guide rails guiding the sliders to move the lid arrangement between the closed position and the uncovering position, each guide rail being integrated into one lateral fixed-roof region and covered by an outer roof skin; and
a second lid member forming part of the lid arrangement and bordering on the first lid member when the lid arrangement is in the closed position, wherein when the lid arrangement moves from the closed position to the uncovering position, each slider move along one of the guideways and guides the first lid member, such that the first lid member performs a lifting movement relative to the second lid member when the lid arrangement moves toward the uncovering position.
